(19) United States
(12) Patent Application Publication
(10) Pub. No.: US 2026/0268891 A1
(43) Pub. Date: Sep. 10, 2026

(54) MACHINE LEARNING SYSTEMS TO CONDUCT INMATE ASSESSMENT INTERVIEWS

(71) Applicant: Allvest Information Services, Inc., Bountiful, UT (US)

(72) Inventors: Sean B.D. Hosman, Nashville, TN (US); Casey L. Riley, Middleton, ID (US); Marjorie K. Rist, Nashville, TN (US); Benjamin P. Snell, Meadow, UT (US); Jasper M. Swensen, Seattle, WA (US)

(73) Assignee: Allvest Information Services, Inc., Bountiful, UT (US)

(21) Appl. No.: 19/375,903

(22) Filed: Oct. 31, 2025

Related U.S. Application Data
(60) Provisional application No. 63/769,397, filed on Mar. 10, 2025.

(51) Int. Cl. G10L 13/08; G06N 20/00; G10L 15/26

(52) U.S. Cl. CPC G10L 13/08; G06N 20/00; G10L 15/26

(57) ABSTRACT

Systems and methods for automatically conducting an assessment interview to predict risks an individual poses to self and others by executing an interview conducting machine-learning model using as input interviewee responses and interview guidance to generate interviewer questions and responses, the interview guidance including guidelines for assessing individuals for risks to themselves and others, and generating an interview transcript including the interviewer questions, the interviewee responses, and the interviewer responses, automatically generating assessment inputs based on the assessment interview by, generating, based on the interviewee responses, assessment inputs, and providing the assessment inputs as input to an analysis engine to generate an assessment of the individual, the assessment reflecting a prediction of risks the individual poses to self and others, automatically generating a report on the assessment by generating, based on the interview transcript and sensor data collected during the assessment interview, a confidence score for the assessment.

### CROSS-REFERENCE TO RELATED APPLICATIONS

This application claims priority to U.S. Provisional Application No. 63/769,397, filed Mar. 10, 2025, which application is incorporated by reference herein in its entirety.

### BACKGROUND

In-person interviews and assessments can be an important component of evaluating a risk that inmates may pose to themselves and others. However, in-person interviews are limited by the availability and expertise of personnel trained to conduct these interviews and to generate assessments of inmates. Furthermore, variations in assessments may be caused by a mood, disposition, or bias of an interviewer, reducing their effectiveness.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is an illustration of an example system for generating prescriptive recommendations for individuals involved with public safety agencies.

FIG. 2 is an illustration of an example system for conducting assessment interviews.

FIG. 3 is an illustration of an example system for conducting assessment interviews.

FIG. 4 is a flow chart illustrating operations of an example method for automatically conducting assessment interviews, generating assessment responses based on the assessment interview, and evaluating an effectiveness of the assessment interview.

FIG. 5 is a flow chart illustrating operations of an example method for automatically conducting assessment interviews.

FIG. 6 is an illustration of an example computer system.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Public safety institutions, such as prisons, perform actuarial assessments on an individual throughout the lifecycle of the individual’s involvement with the institutions. Assessments are used at various different stages and by various different institutions such as jails, courts, prisons, probation boards, and parole boards. Many of these assessments require extensive questioning of the individual in order to identify risks. This questioning of the individual can take anywhere from 40 minutes to multiple hours depending on the state of the individual being assessed. The interview is often conducted without an assessment directly in front of the interviewer, so that the interviewer can engage with the interviewee in a conversational manner. Interviewers are often trained in techniques like motivational interviewing, where the interviewer asks open-ended questions while acknowledging previous interviewee response to demonstrate empathy. Once the interviewer feels they have collected enough information, they can go back to their desk and fill in the responses to the predictive assessment. Some of the risk and needs assessments used in public safety can include over a hundred questions with each question having many possible responses. These responses are inputs to the predictive model, with each possible response having an assigned predictive weight to it to provide a risk prediction.

An interview may not yield all of the information required to complete the assessment. An interviewer can return to the interviewee for a subsequent interview to try to collect whatever remaining information they failed to collect the first time. They may also have to collect data from various sources to provide responses that include counts of occurrences such as criminal convictions found in a criminal history database. Collecting information in an interview, tabulating responses based on the interview, and retrieving data from external sources to complete the assessment is a time-consuming process with many opportunities for human error to render the assessment inaccurate.

Assessments are often required to be performed on an individual to track changes that affect predictive outcomes. The model outcomes are used to drive the institution’s decision-making efforts and used as inputs for prescriptive models that generate recommendations for allocations of resources. The high-effort, time-consuming nature of these assessments, along with their frequency and capacity for inaccuracy due to human error pose several significant challenges including high cost, inaccuracy due to interviewer error, inaccuracy due to interviewee deception, and inaccuracy due to interviewer bias.

Examples and embodiments discussed herein solve these problems by providing systems and methods for automatically conducting interviews, interpreting interview responses to provide input to assessments, and evaluating the process to ensure that the assessment predictions are accurate. Examples and embodiments discussed herein include an interview engine to automatically conduct interviews with individuals. The interview engine can use a text-to-speech (TTS) model to play interview questions over a speaker designed to elicit responses corresponding to an assessment and use a speech-to-text (STT) model to generate text based on interviewee responses. The interview engine can generate a transcript based on the interview questions and store the transcript in a database. An interpretation engine can retrieve the transcript from the database and map questions to responses in the transcript. Based on the mapped questions and responses, the interpretation engine can generate assessment inputs (e.g., responses) to use as input to an assessment. A quality control engine can use sensor data collected during the interview, the transcript, and the assessment inputs to evaluate an accuracy of a prediction generated using the assessment and/or a performance of the system in automatically conducting and interpreting the interview.

By separating the conducting of the interview, the interpretation of the interview, and the evaluation of the interview, a process of generating a prediction can be rendered more accurate and more explainable. By generating intermediate data at each stage (e.g., the transcript, assessment inputs, quality control report), the automatic process can be human-understandable and machine-verifiable. Moreover, separate machine-learning systems for the conducting of the interview, the interpretation of the interview, and the evaluation of the interview can mutually reinforce one another’s effectiveness, as consistently conducted interviews allow for more consistent and accurate interpretation, which improves evaluation of the interview. In this way, the systems and methods disclosed herein can solve the technical problem of inaccurate, time-intensive interviews while providing highly accurate, consistent, and verifiable results.

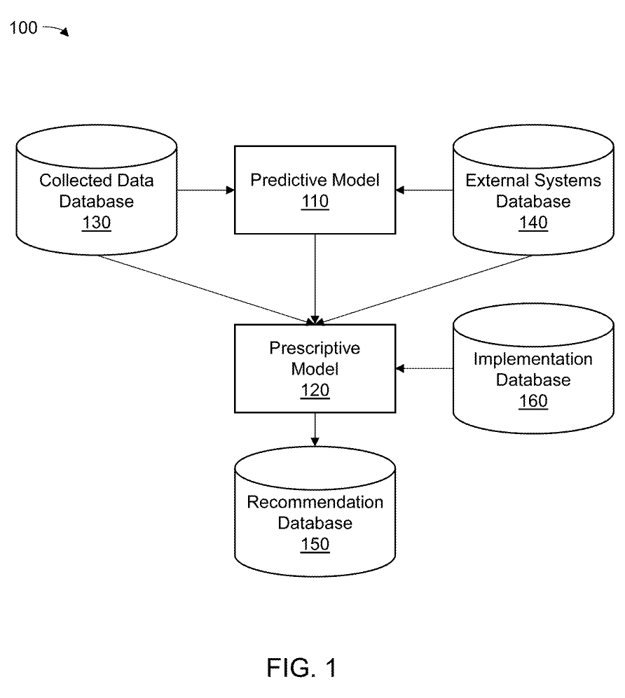

FIG. 1 is an illustration of an example system 100 for generating prescriptive recommendations for individuals involved with public safety individuals, such as inmates, incarcerated individuals, and individuals on parole. The system 100 includes a predictive model 110, a prescriptive model 120, a collected data database 130, an external systems database 140, a recommendation database 150, and an implementation database 160.

The predictive model 110 receives, as input, data from the collected data database 130 and the external systems database 140 to generate predictions. The predictive model 110 can be a machine-learning model such as a support vector machine, a decision tree, ensemble trees, a generalized additive model, a neural network, a naïve Bayes model, a k-nearest neighbor, a discriminant analysis model, linear regression mode, a non-linear regression model, a generalized linear model, or a gaussian process regression. In some implementations, the predictive model 110 receives, as input, data from additional databases and/or other sources. The predictive model 110 can be trained to generate predictions. For example, the predictive model 110 can be trained to generate predictions as to a likelihood of recidivism for an individual. The likelihood of recidivism can be understood as a likelihood of relapse into a prior negative (e.g., harmful, undesirable) behavior pattern, whether or not criminal. The predictive model 110 can be trained to generate predictions as to a likelihood of an individual committing a predetermined set of crimes. In an example, the predictive model 110 is trained to classify individuals into three risk groups: low risk, moderate risk, and high risk. The risk can encompass any range of impact, including negative impact, harmful impact, adverse impact, undesirable impact, or the like, to self and/or to others. As can be appreciated, in some embodiments the risk can be a near term risk (e.g., ranging from immediate, hours, days, weeks, months, years), in some embodiments the risk can be a long term risk (e.g., ranging from a year, to several years, to a decade, to several decades), and in some embodiments the risk can be both near term and long term. In an example, the predictive model 110 is trained to generate a probability vector including a probability for committing each crime in a set of crimes.

The data in the collected data database 130 may be data collected from individuals, such as survey data. The data in the external systems database 140 may be data collected from other sources, such as government databases, court records, employment records, health records, police reports, and other sources. The data in the collected data database 130 and the data in the external systems database 140 that are provided to the predictive model 110 as input can be referred to as “input data.” The input data to the predictive model 110 for an individual can include a set of features (i.e., assessment features). In an example, the set of features can include one or more of the following: whether the individual is in touch with positive friends, whether the individual is in touch with negative friends, whether the individual is experiencing family conflict, an education level of the individual, an employment history of the individual, a mental health history of the individual, a physical health history of the individual, an arrest history of the individual, an alcohol use history of the individual, a drug use history of the individual, and/or a self-assessment of the individual. In this example, each of the features is assigned a weight, where a weighted sum of the features is a risk score for the individual. Weights for the predictive model 110 are learned during training of the predictive model 110.

The predictive model 110 can be updated (e.g., trained further, parameters/weights updated) based on data from the collected data database 130 and/or the external systems database 140. In an example, the predictive model 110 can be updated based on actual recidivism data from the collected data database 130 and/or the external systems database 140. In an example, the predictive model 110 generates a risk score of 90% for an individual for recidivism within 6 months if no intervention takes place, and the predictive model 110 is updated based on the individual not recidivating within 6 months despite a lack of intervention. The output of the predictive model 110 is provided as input to the prescriptive model 120.

The prescriptive model 120 is executed using, as input, the output of the predictive model 110 and/or data from the collected data database 130 and/or the external systems database 140 to generate prescriptive recommendations. The prescriptive model 120 can be a machine-learning model such as a support vector machine, a decision tree, ensemble trees, a generalized additive model, a neural network, a naïve Bayes model, a k-nearest neighbor, a discriminant analysis model, linear regression model, a non-linear regression model, a generalized linear model, or a gaussian process regression. In an example, risk scores for a set of individuals and the underlying data used to generate those risk scores are provided as input to the prescriptive model 120 to generate a recommendation for allocating resources to the set of individuals. The risk scores can represent risks for individuals, such as recidivism risk, if no intervention is performed, or no resources are provided to the individuals. The prescriptive model 120 generates recommendations for allocating services and resources to the individuals in order to efficiently allocate resources to lower the risks. In an example, the predictive model 110 outputs risk scores for a set of incarcerated individuals to be released, the risk scores representing a likelihood of recidivism for each individual, and the prescriptive model 120 generates recommendations for resources to be allocated to each individual to lower the overall recidivism risk for the set of incarcerated individuals. In some implementations, the recommendations generated by the prescriptive model 120 include modified risk scores as a prediction of how the risk scores can be reduced by implementing the recommendations. The recommendations generated by the prescriptive model 120 are stored in the recommendation database 150.

The prescriptive model 120 can be updated (e.g., trained further, parameters/weights updated) based on data from the collected data database 130, the external systems database 140, and/or the implementations database 160. In an example, the prescriptive model 120 can be updated based on actual implementation data from the implementations database 160. In an example, the prescriptive model 120 generates an intervention recommendation for an individual to reduce a risk of recidivism, the intervention is implemented, the individual recidivates, and the prescriptive model 120 is updated based on the individual recidivating despite the recommended intervention.

The recommendation database 150 can be updated based on information from the implementation database 160 and the collected data database 130 and/or the external systems database 140. The implementation database 160 includes data on implementation of interventions, including interventions reflected in the recommendations generated by the prescriptive model 120. In an example, the prescriptive model 120 is updated based on recidivism data for individuals as well as interventions performed for those individuals. In an example, the prescriptive model 120 generates a recommendation to assign an employment specialist to an individual to reduce a recidivism risk for the individual from 80% to 20%, and the prescriptive model 120 is updated based on the individual recidivating despite the assignment of the employment specialist to the individual.

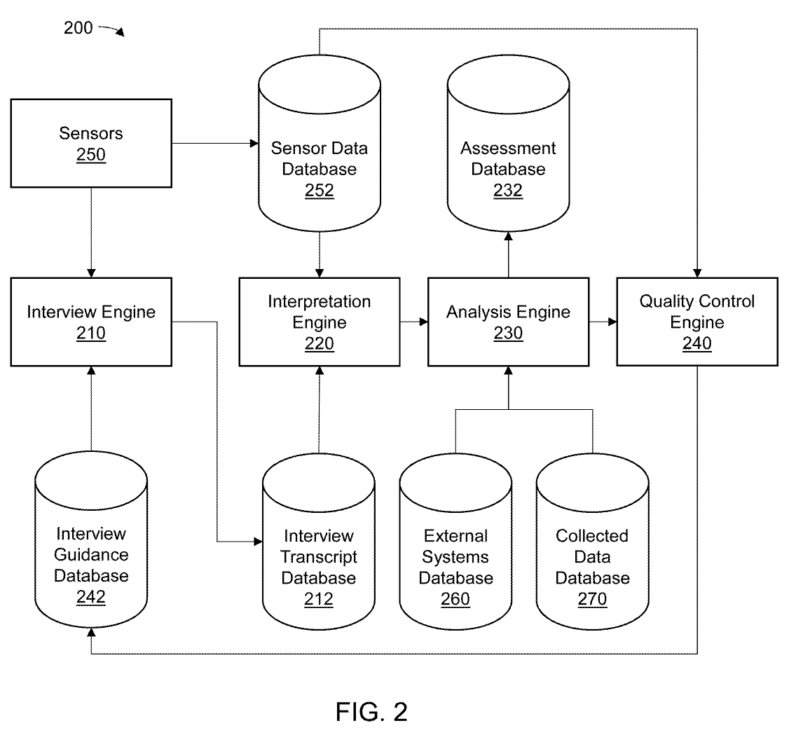

FIG. 2 is an illustration of an example system 200 for conducting assessment interviews. The system 200 includes an interview engine 210, an interpretation engine 220, an analysis engine 230, a quality control engine 240, sensors 250, an interview transcript database 212, an assessment database 232, an interview guidance database 242, a sensor data database 252, an external systems database 260, and a collected data database 270.

The interview engine 210 can automatically conduct an assessment interview with an individual, without human intervention. The interview engine 210 can generate interview questions related to an assessment, receive interviewee responses, respond to interviewee responses. The interview engine 210 can receive, as input, sensor data from the sensors 250 and interview guidance from the interview guidance database 242. The sensor data from the sensors 250 can include the interviewee responses. The interview guidance from the interview guidance database 242 can include information related to the assessment.

The sensors 250 can include a microphone, a camera, and biometric sensors. The sensors 250 can record sensor data associated with an individual being interviewed, such as audio including speech of the individual, video of the individual, heart rate of the individual, eye movement of the individual, temperature of the individual, and other parameters.

The interview guidance can include an indication of an assessment for which the interview is being performed, assessment inputs for the assessment, a language in which the interview is being performed, and interviewing guidelines. In some implementations, the interview guidance includes prompts including guidelines on motivational interviewing, such as prompts for questions that refer back to previous interviewee responses, prompts for questions using an empathetic tone, and prompts for questions that are open-ended and which invite disclosure.

The interview engine 210 can include a machine-learning model (e.g., an interview conducting machine-learning model). In some implementations, the interview engine 210 includes a large language model (LLM). The interview engine 210 can include a speech-to-text (STT) model and a text-to-speech (TTS) model. The interview engine 210 can execute the machine-learning model using as input the interview guidance to generate questions, execute the TTS model to generate audio from the generated questions, and play the generated audio using a speaker to pose a question to the interviewee. The interview engine 210 can cause the question to be displayed on a screen or monitor to the interviewee. The interviewee can speak a response and/or type a response. The interview engine 210 can execute the STT model to generate text from a spoken response from the interviewee. The interview engine 210 can store the text of the interviewee response in memory. The interview engine 210 can execute the machine-learning model to generate a response/question, display the response/question on the screen, and execute the TTS model to play audio over the speaker generated from the response/question. The interview engine 210 can execute the machine-learning model using as input the interview guidance, the sensor data, previous questions, and previous responses to generate subsequent questions for the interviewee. The interview engine 210 continues to receive responses from the interviewee and generate questions and responses for the interviewee until the assessment interview is completed. When the assessment interview is completed, the interview engine 210 can store a transcript of the assessment interview to the interview transcript database 212.

The interview engine 210 may dynamically adjust interview execution in real time based on interviewee responses and behavior as reflected in the sensor data and the transcript. In some implementations, the interview engine 210 monitors the ongoing interview transcript and sensor data to identify patterns or indicators that may suggest the need for modified questioning approaches. For example, the interview engine 210 may detect through sensor data that an interviewee's heart rate has elevated or that their speech patterns have changed when discussing particular topics, and may adjust subsequent questions to explore these areas more thoroughly or to provide reassurance to the interviewee. In some cases, the interview engine 210 may identify inconsistencies between current responses and earlier statements in the transcript, prompting the generation of follow-up questions to clarify or resolve discrepancies. The interview engine 210 may also adjust the pacing, tone, or complexity of questions based on the interviewee's comprehension level as indicated by their response patterns and the time taken to respond. In some aspects, the interview engine 210 may modify its questioning strategy mid-interview if sensor data indicates signs of fatigue, stress, or disengagement, potentially shifting to more direct questions or providing breaks as appropriate to maintain the quality and accuracy of the assessment interview.

In some implementations, the interview engine 210 generates the interview transcript to include analysis of the machine-learning model used to generate questions. In an example, the machine-learning model is an LLM that is prompted to generate interview questions and to explain why the interview questions were generated, and the interview transcript includes the questions generated by the LLM, the reasoning the LLM used to generate the questions, and the interviewee responses to the questions. In some implementations, the interview transcript includes analysis or reasoning of the machine-learning model regarding the interviewee responses. In an example, the interview transcript includes reasoning of the machine-learning model to generate a question, the question, an interviewee response, and analysis of the interviewee response by the machine-learning model. In this example, the analysis of the interviewee response can be part of reasoning of the machine-learning model to generate a subsequent question.

The interview engine 210 can determine that the assessment interview is completed based on the interview guidance. In an example, the interview guidance includes responses for the assessment, and the interview engine continues the assessment interview until it has collected data corresponding to all of the responses for the assessment. The interview engine 210 may generate follow-up guidance and iteratively ask follow-up questions until a desired level of completeness is reached for the assessment. In some implementations, the interview engine 210 evaluates the completeness of collected information by comparing the current interview responses against the required assessment inputs specified in the interview guidance. The interview engine 210 may determine that certain assessment areas require additional exploration based on incomplete, ambiguous, or contradictory responses from the interviewee. In such cases, the interview engine 210 may generate targeted follow-up questions designed to elicit more specific information or clarify previous responses. The interview engine 210 may also generate follow-up guidance that adjusts the questioning approach, such as rephrasing questions in simpler language, providing examples to help the interviewee understand what information is being sought, or using alternative questioning techniques when initial approaches prove ineffective. The interview engine 210 may continue this iterative process of generating follow-up questions and guidance until predetermined completeness criteria are satisfied, such as obtaining responses for all required assessment inputs, achieving minimum confidence thresholds for key responses, or reaching a maximum interview duration limit.

The sensors 250 provide the sensor data to the interview engine 210 during the interview to allow the interview engine 210 to generate questions and responses based on the sensor data. In an example, the interview engine 210 can determine, based on an elevated heart rate of the interviewee, that the interviewee is agitated or distressed by a question. In this example, the interview engine 210 can generate questions to determine why the interviewee is agitated and how the interviewee’s agitation relates to the assessment. In an example, the interview engine 210 can determine, based on eye movements of the interviewee, that the interviewee is lying. In this example, the interview engine 210 can generate questions to determine why the interviewee is lying and to determine the truth.

The sensors 250 store the sensor data to the sensor data database 252. The sensor data database 252 can store the raw sensor data collected during the assessment interview. The sensor data can include time-series data which can be correlated with the transcript stored in the interview transcript database 212.

The interpretation engine 220 can automatically interpret the interview transcript to determine assessment inputs (i.e., assessment responses, assessment features) for the analysis engine 230. The interpretation engine 220 can receive as input the interview transcript to generate a data structure that can be used as input to the analysis engine 230. The interpretation engine 220 can retrieve the interview transcript from the interview transcript database 212. The interpretation engine 220 can generate a mapping that maps questions in the interview transcript to interviewee answers in the interview transcript. The interpretation engine 220 can generate a mapping that maps questions and/or interviewee answers in the interview transcript to assessment inputs (i.e., assessment responses, assessment features). In this way, the interpretation engine 220 can map data from the interview to the assessment inputs for the analysis engine 230.

In some implementations, the interpretation engine 220 executes a machine-learning model using as input the interview transcript and the assessment (e.g., assessment questions) to generate the assessment inputs (i.e., assessment responses, assessment features). The interpretation engine 220 can also generate reasoning relied upon in generating the assessment inputs. In some implementations, the reasoning includes citations to portions of the interview transcript. In an example, the interpretation engine 220 executes an LLM using as input the interview transcript and the assessment questions to generate the assessment responses along with reasoning to support the generated assessment responses. In this way, assessment inputs are generated by the interpretation engine 220 based on the interviewee answers without relying on explicit matches between the interviewee answers in the interview transcript and the assessment inputs.

The interpretation engine 220 can generate confidence scores for interviewee answers. In some implementations, the interpretation engine 220 generates confidence scores for the interviewee answers using one or more of the corresponding interviewer questions, the analysis used to generate the questions, the interviewee answers, and analysis of the interviewee answers. In some implementations, the interpretation engine 220 retrieves the sensor data from the sensor data database 252 and uses the sensor data database 252 to generate confidence scores for interviewee answers. In an example, an elevated heart rate, sweating, and rapid eye movement may indicate that the interviewee was or could have been lying, causing the interpretation engine 220 to generate a low confidence score for an interviewee answer. The interpretation engine 220 can generate an overall confidence score for the assessment interview based on the confidence scores for the interviewee answers.

In some implementations, the interpretation engine 220 generates a data structure including, for each assessment input, an answer generated by the interpretation engine 220 based on the interview transcript, reasoning to support the generated answer, and a confidence score for the answer. The data structure can include structure to associate the assessment input, the answer, the reasoning, and the confidence score such that the assessment input can be provided as input to the assessment. In an example, the interpretation engine 220 generates a JSON file including JSON objects that each include an assessment question, an answer to the assessment question generated by the interpretation engine 220 based on the interview transcript, reasoning for the answer, and a confidence score for the answer. In this example, the JSON file can be used to provide input to the analysis engine 230, where the answers are used as assessment inputs or assessment responses.

The interpretation engine 220 can generate an evaluation of the interviewer, indicating whether the questions the interviewer asked collected information sufficient to provide assessment responses for the assessment. In some implementations, the interpretation engine 220 can generate the evaluation of the interviewer based on the confidence scores for the interviewee answers and/or the overall confidence score for the assessment interview, indicating whether the interpretation engine 220 has confidence that the assessment interview provided accurate information for use as assessment inputs.

In some implementations, the interpretation engine 220 may provide the evaluation of the interview engine 210 to the interview engine 210 in real time during the assessment interview to enable dynamic adjustment of interview execution. The interpretation engine 220 may continuously analyze portions of the interview transcript as they are generated and provide feedback to the interview engine 210 regarding the quality and completeness of information being collected. For example, the interpretation engine 220 may determine that certain assessment areas are not being adequately addressed based on the current line of questioning and may signal to the interview engine 210 that additional exploration is needed in specific domains. The interpretation engine 220 may also identify when interviewee responses are insufficient, ambiguous, or potentially inconsistent with earlier statements, prompting the interview engine 210 to generate more targeted follow-up questions. In some cases, the interpretation engine 220 may provide real-time confidence scores for different portions of the interview, allowing the interview engine 210 to focus additional attention on areas where confidence scores are low. This real-time feedback loop may enable the interview engine 210 to adapt its questioning strategy dynamically, potentially improving the overall quality and completeness of the assessment interview while it is still in progress.

The interpretation engine 220 can provide the assessment inputs to the analysis engine 230. In some implementations, the interpretation engine 220 makes API calls to the analysis engine 230 to provide the assessment inputs to the analysis engine 230. In some implementations, a software agent makes API calls to the analysis engine 230 to provide the assessment inputs to the analysis engine 230.

The analysis engine 230 can execute assessments to generate risk predictions and/or intervention recommendations for individuals. The analysis engine 230 can include the predictive model 110 and/or the prescriptive model 120 of FIG. 1. The analysis engine 230 can execute an assessment model corresponding to the assessment engine using as input the assessment inputs provided by the interpretation engine 220 and data from the external systems database 260 and/or the collected data database 270. The external systems database 260 can be the same as or similar to the external systems database 140 of FIG. 1. The collected data database 270 can be the same as or similar to the collected data database 130 of FIG. 1. The analysis engine 230 can store an assessment result (e.g., predictions and/or recommendations) generated by the assessment model using as input the assessment inputs in the assessment database 232.

The quality control engine 240 receives the completed assessment and the assessment result (e.g., predictions and/or recommendations) from the analysis engine 230. In some implementations, the quality control engine 240 retrieves the completed assessment and the assessment result from the assessment database 232. The quality control engine 240 can receive the sensor data from the sensor data database 252. The quality control engine 240 can execute a set of machine-learning models using as input the sensor data and the interview transcript to perform veracity checks on the interviewee’s statements. In an example, one or more machine-learning models are configured to receive, as input, audio from the interview to analyze a tone of voice of the interviewee, speech patterns of the interviewee, word choice of the interviewee, and other speech parameters to determine an emotional state of the interviewee, a degree of spontaneity in the interviewee’s speech, and/or whether the interviewee is lying. In an example, one or more machine-learning models are configured to receive, as input, video data from the interview to analyze eye movements of the interviewee, body language of the interviewee, and/or hand movements of the interviewee to determine an emotional state of the interviewee, and/or whether the interviewee is lying. The set of machine-learning models can be executed according to a configuration that indicates which machine-learning models are to be executed for conducting veracity checks. The set of machine-learning models may each generate a veracity confidence score for different portions of the interview. The set of machine-learning models can generate the veracity confidence scores corresponding to time stamps in the interview transcript. The quality control engine 240 may generate an overall veracity confidence score based on the veracity confidence scores generated by the set of machine-learning models. In an example, the quality control engine 240 generates an overall veracity confidence score for a time stamp based on the veracity confidence scores generated by the set of machine-learning models. In an example, the quality control engine 240 generates an overall veracity confidence score for a portion of the assessment interview corresponding to a portion of the assessment. In an example, the quality control engine 240 generates an overall veracity confidence score for the assessment interview.

The quality control engine 240 may generate an evaluation of the interpretation engine 220 and/or the interview engine 210. The evaluation of the interpretation engine 220 can indicate whether the interpretation engine 220 generated correct answers based on the interview transcript. In an example, the evaluation of the interpretation engine 220 indicates whether the interpretation engine 220 used truthful statements in generating the assessment inputs. In an example, the evaluation of the interpretation engine 220 compares the assessment inputs generated by the interpretation engine 220 to the reasoning for the assessment inputs generated by the interpretation engine 220 to determine whether the reasoning supports the assessment inputs. In an example, the evaluation of the interpretation engine compares the assessment inputs generated by the interpretation engine 220 to assessment inputs generated by the quality control engine 240. The evaluation of the interview engine 210 may indicate whether the questions of the interview collected information sufficient to provide assessment responses for the assessment. In some implementations, the evaluation of the interview engine 210 indicates whether the interview engine 210 identified and/or responded to inconsistent statements or lies told by the interviewee.

In some implementations, the quality control engine 240 retrieves information from the external systems database 260 and/or the collected data database 270 and compares the retrieved data to interviewee responses in the interview transcript to determine whether the interviewee responses correspond to previously-collected data and/or statements of record. In an example, the quality control engine 240 can compare a conviction history of the interviewee to interviewee responses regarding the conviction history. In an example, the quality control engine 240 can compare a medical history of the interviewee to interviewee responses regarding use of prescription drugs. These questions can be referred to baseline questions. The quality control engine 240 can use the baseline questions to establish baseline biometrics (e.g., baseline heart rate, baseline body language, etc.) in generating veracity confidence scores. The quality control engine 240 can use the baseline questions in generating an overall veracity confidence score for the assessment interview. In an example, a veracity confidence score (e.g., 100% true or 100% false reflecting the ground-truth nature of the baseline questions) generated based on systems of record to an interviewee response is weighted higher than other questions in generating the overall veracity confidence for the assessment interview.

The quality control engine 240 may update the interview guidance in the interview guidance database 242 based on the evaluation of the interview engine 210 and/or the analysis engine 230. The quality control engine 240 may update the interview guidance to improve a performance of the interview engine 210 in subsequent interviews. In an example, the quality control engine 240 updates prompts in the interview guidance to improve interview questions generated by an LLM of the interview engine 210. In this way, the system 200 can be updated based on past performance to learn from prior interviews and improve an accuracy of assessments performed using the system 200.

In some implementations, the quality control engine 240 may generate recommended changes to prompts in the interview guidance database 242 for review and approval by a human analyst or other supervisory system before implementation. The quality control engine 240 may analyze patterns in interview performance, assessment accuracy, and veracity confidence scores to identify areas where interview guidance may be improved. Based on this analysis, the quality control engine 240 may generate specific recommendations for modifying prompts, adjusting questioning strategies, or updating interview protocols. These recommendations may be presented to a human analyst through a user interface that displays the proposed changes alongside supporting data and rationale. The human analyst may review the recommended changes, approve modifications, reject suggestions, or provide additional guidance for refinement. In some cases, the quality control engine 240 may route recommendations to an automated approval system that applies predetermined criteria to evaluate proposed changes. Once approved, the recommended changes may be implemented in the interview guidance database 242 to enhance the performance of the interview engine 210 in subsequent assessment interviews.

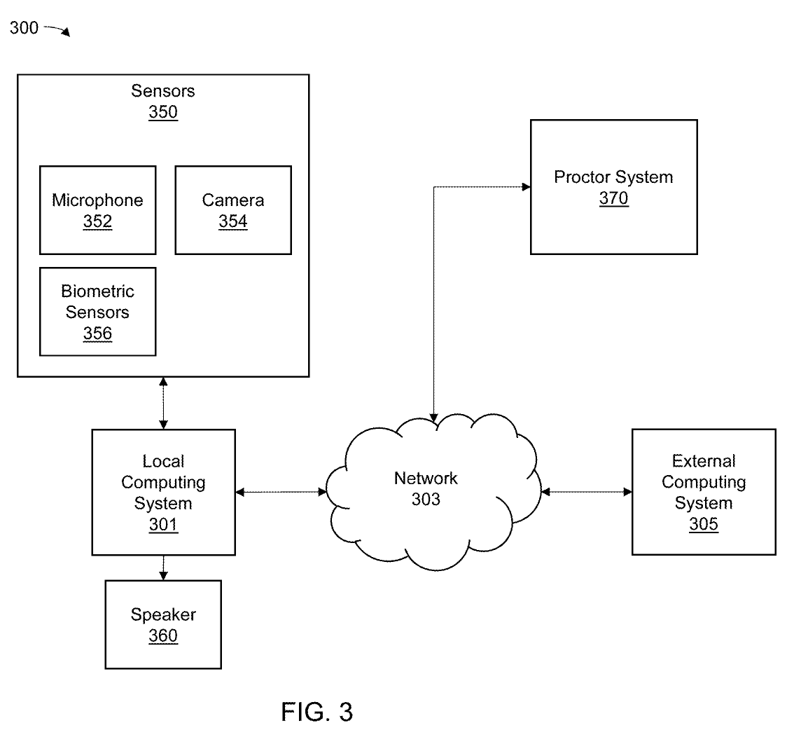

FIG. 3 is an illustration of an example system 300 for conducting assessment interviews. The system 300 includes sensors 350, a speaker 360, a local computing system 301, a network 303, an external computing system 305, and a proctor system 370. The system 300 may be an implementation of the system 200 of FIG. 2, with the system 200 generally corresponding to the external computing system 305 with the sensors 250 corresponding to the sensors 350.

The local computing system 301 receives sensor data from the sensors 350. The sensors 350 include a microphone 352, a camera 354, and biometric sensors 356. The sensors 350 can include more sensors than illustrated, such as a thermometer, a humidity sensor, and other sensors. The local computing system 301 can transmit the sensor data via the network 303 to the external computing system 305. The external computing system 305 may receive the sensor data and generate interview questions for an assessment interview.

In some implementations, the external computing system 305 receives audio including interviewee speech, generates interviewee text based on the received audio, and executes a machine-learning model (e.g., an LLM) using as input the interviewee text to generate interviewer text, converts the interviewer text into interviewer speech, and transmits audio including the interviewer speech via the network 303 to the local computing system 301. The local computing system 301 can play the audio including the interviewer speech over the speaker 360. In this way, the external computing system 305 can automatically conduct an assessment interview using the hardware (i.e., the sensors 350 and the speaker 360) coupled to the local computing system 301.

The external computing system 305 can be connected, via the network 303, to a plurality of local computing systems 301 for automatically conducting interviews with a plurality of interviewees in a plurality of locations. In this way, the external computing system 305 can provide consistent interview practices in a variety of different settings and geographic locations, and can update its machine-learning models based on the different interviews to provide accurate, consistent assessment interviews. In some implementations, the external computing system 305 is a cloud-based computing system. In an example, the external computing system 305 connects to local computing systems 301 in prisons across the state of California to provide consistent, accurate assessment interviews with prisoners for providing assessment predictions and/or recommendations that are consistent for prisoners across the state of California.

The proctor system 370 can communicate, via the network 303, with the sensors 350, local computing system 301, and external computing system 305 to facilitate monitoring and coordination during assessment interviews. This communication enables the proctor system 370 to receive real-time data streams from multiple sources and coordinate responses across the distributed system architecture. For example, the proctor system 370 may receive biometric data from the sensors 350 while simultaneously accessing interview analysis from the external computing system 305 to provide a holistic view of the interview session. In another example, the proctor system 370 can coordinate with the local computing system 301 to pause an interview while communicating with the external computing system 305 to adjust interview parameters based on detected conditions.

The proctor system 370 can provide alerts to a human proctor based on data generated by the external computing system 305 and/or the sensors 350, enabling immediate human intervention when automated systems detect conditions requiring attention. These alerts can be triggered by various combinations of sensor data and analysis results that indicate potential issues or safety concerns during the assessment interview process. For example, the proctor system 370 may generate an alert when the external computing system 305 detects inconsistent responses in combination with elevated heart rate data from the sensors 350, suggesting potential deception or distress. In another example, the proctor system 370 can alert a human proctor when the sensors 350 detect unusual movement patterns while the external computing system 305 indicates that the interview has stalled or the individual has become unresponsive, potentially indicating a medical emergency or behavioral crisis.

In some implementations, the proctor system 370 can provide specific alerts to a human proctor based on detected conditions, including alerts that an individual needs a bathroom break, that an individual poses an imminent risk to self or others, or that an individual is in danger of imminent cardiac arrest. These alerts can be generated through analysis of multiple data streams (e.g., sensor data and interview transcript) and can trigger different levels of response protocols depending on the severity and nature of the detected condition. For example, the proctor system 370 may detect fidgeting behavior and verbal cues indicating discomfort, prompting an alert for a bathroom break, or it may identify aggressive posturing combined with threatening language to generate a safety risk alert. In another example, the proctor system 370 can monitor heart rate variability and detect irregular patterns that, when combined with other physiological indicators such as rapid breathing or sweating, may trigger an alert for potential cardiac distress requiring immediate medical attention.

In some implementations, the proctor system 370 can be a computing device that is present with the sensors 350 in the same physical location as the interviewee, providing on-site monitoring and immediate response capabilities. This local presence allows the proctor system 370 to have direct access to environmental conditions and immediate physical oversight of the interview process. For example, the proctor system 370 may be implemented as a tablet or dedicated monitoring station positioned in the interview room, allowing a human proctor to observe real-time sensor data while maintaining visual contact with the interviewee. In another example, the proctor system 370 could be integrated into a wall-mounted display system that shows vital signs, interview progress, and alert notifications while providing two-way communication capabilities between the interviewee and remote human supervisors.

In some implementations, the proctor system 370 can be part of the local computing system 301, integrating monitoring and alert functions directly into the local hardware infrastructure. This integration allows for streamlined data processing and reduced network latency while maintaining comprehensive oversight capabilities. For example, the proctor system 370 functionality may be implemented as software modules running on the local computing system 301, processing sensor data locally and generating alerts without requiring constant network communication with external systems. In another example, the local computing system 301 may include dedicated proctor system 370 hardware components such as specialized alert displays, emergency communication devices, or automated response mechanisms that can operate independently even if network connectivity is temporarily lost.

In other implementations, the proctor system 370 can be part of the external computing system 305, providing centralized monitoring capabilities across multiple interview locations and enabling coordinated oversight of distributed assessment operations. This centralized approach allows for consistent monitoring protocols and expert oversight across multiple sites while leveraging advanced processing capabilities and comprehensive data analysis. For example, the proctor system 370 may operate as a cloud-based service, monitoring multiple simultaneous interviews across different correctional facilities and routing alerts to appropriate regional supervisors based on location and severity.

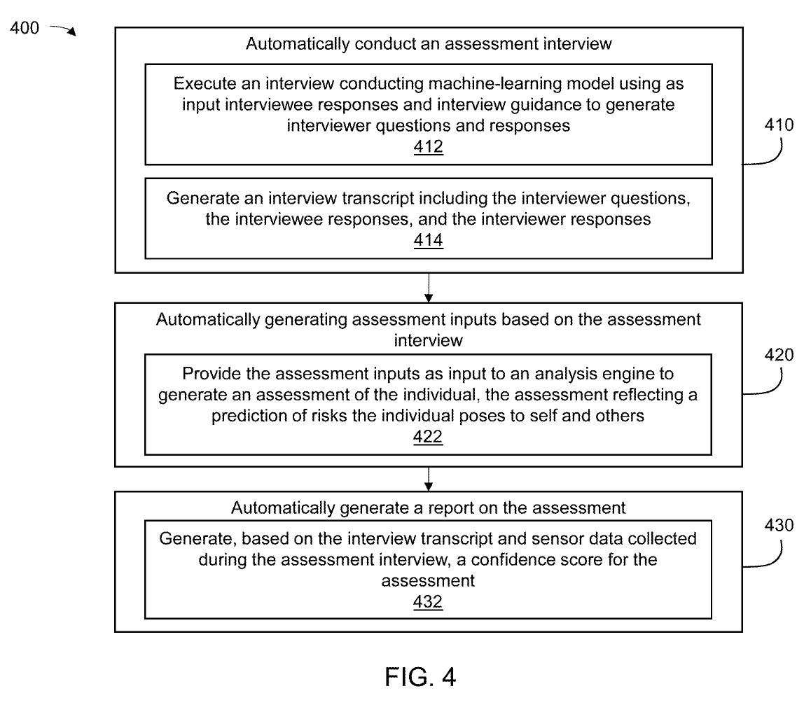

FIG. 4 is a flow chart illustrating operations of an example method 400 for automatically conducting assessment interviews, generating assessment responses based on the assessment interview, and evaluating an effectiveness of the assessment interview. The method 400 can include more, fewer, or different operations than shown. One or more operations can be performed in the order shown, in a different order, or concurrently. The method 400 can be performed by one or more components of the system 200 of FIG. 2 or the system 300 of FIG. 3.

At operation 410, an assessment interview is automatically conducted. The interview can be conducted to predict risks an individual poses to self and others. The assessment interview may be automatically conducted using one or more machine-learning models. At operation 412, an interview conducting machine-learning model is executed using as input interviewee responses and interview guidance to generate interviewer questions and responses. The assessment interview can be automatically conducted by receiving, from a microphone, audio including interviewee speech of an individual being assessed, converting the interviewee speech into interviewee text, and executing an interview-conducting machine-learning model using as input the interviewee text and interview guidance to generate interviewer text. The interview guidance can include guidelines for assessing individuals for risks to themselves and others. The interviewer text can be converted into interviewer speech. The interviewer speech can be played or otherwise presented as audio from a speaker. Conversion of speech into text can be performed by a speech-to-text machine-learning model. Conversion of text into speech can be performed by a text-to-speech machine-learning model. In an example, the interview conducting machine-learning model can be an LLM and the interview guidance can include prompts for the LLM. The interview guidance may include guidelines for assessing individuals for risks to themselves and others. The interview guidance may include assessment questions and response options to the assessment questions. The interview guidance may include instructions to ask questions corresponding to the assessment questions and to ensure that interviewer questions result in interviewee answers that correspond to the response options to the assessment questions. In this way, the interview guidance assists the interview-conducting machine-learning model in conducting a complete assessment interview that elicits information needed for the assessment.

At operation 414, an interview transcript is generated including the interviewer questions, interviewee responses, and interviewer responses. The interview-conducting machine-learning model can be executed using as input the interviewer questions, the interviewee responses, and the interviewer responses to generate further interviewer questions. The interview-conducting machine-learning model can be executed using as input the transcript, as the transcript can be generated such that the interview-conducting machine-learning model has context for what has already occurred in the interview. In some implementations, the interview transcript includes reasoning or analysis of the interview-conducting machine-learning model used in generating the interview questions and responses.

At operation 420, assessment inputs are automatically generated based on the assessment interview. The assessment inputs may be generated by executing a machine-learning model using as input the interview transcript to generate the assessment inputs. The machine-learning model can generate a mapping of assessment questions to interviewee responses in the interview transcript. The machine-learning model can generate a mapping of assessment questions to interviewer questions. The machine-learning model can generate a mapping of interviewer questions to interviewee responses in the interview transcript. In some implementations, the machine-learning model generates responses to the assessment questions based on the interview transcript. The machine-learning model may generate reasoning to support the generated responses. In an example, the reasoning cites to the interview transcript. The machine-learning model may generate a confidence score for the generated responses. The machine-learning model may generate a data structure including the assessment inputs. In an example, the machine-learning model generates a JSON file including JSON objects for each assessment question that each include the assessment question, a response to the assessment question, reasoning to support the response, and a confidence score for the response.

At operation 422, the assessment inputs are provided as input to an analysis engine to generate an assessment of the individual, the assessment reflecting a prediction of risks the individual poses to self and others. The machine-learning model, or a software agent, may provide the responses (e.g., a data structure including the responses) to the analysis engine to execute an assessment machine-learning model. In an example, a software agent retrieves a JSON file generated by the machine-learning model including assessment inputs or assessment responses and makes API calls to the analysis engine to prove the assessment inputs as inputs to an assessment executed by the analysis engine.

The analysis engine may execute an analysis machine-learning model using as input the assessment inputs (also referred to herein as assessment responses) to generate risk predictions and/or intervention recommendations. The risk predictions can indicate a risk of the interviewee to self and/or others. The intervention recommendations indicate recommended programs or interventions corresponding to needs of the interviewee. In an example, an interviewee that is predicted to have a high risk of recidivism due to lack of employment prospects may be recommended to be enrolled in a vocational training program to reduce the risk of recidivism.

At operation 430, a report on the assessment is automatically generated. The report can include a summary of the assessment and a confidence score for the assessment. At operation 432, the confidence score for the assessment is generated based on the interview transcript and sensor data collected during the assessment interview. The report on the assessment can be generated by executing a machine-learning model using as input the interview transcript and the sensor data to generate the confidence score for the assessment. The machine-learning model may generate confidence scores for assessment questions and interviewee responses and an overall confidence score for the assessment interview. The confidence scores can be veracity confidence scores indicating a confidence that the assessment inputs reflect the truth (e.g., the interviewee truthfully responded to an interviewer question, the interview transcript was accurately interpreted).

The machine-learning model can receive the assessment from the analysis engine and the sensor data collected during the interview and generate, based on the interview transcript and the sensor data, confidence scores (e.g., veracity confidence scores) for interviewee responses in the interview transcript. The machine-learning model can generate, based on the interview transcript, the confidence scores for the interviewee responses, and the assessment inputs, confidence scores for the assessment inputs. The confidence scores for the assessment inputs can reflect a confidence that the interviewee was truthful in providing responses corresponding to the assessment inputs and/or a confidence that the interviewee responses were accurately interpreted to generate the assessment inputs. The machine-learning model can generate, based on the confidence scores for the assessment inputs, and/or the confidence scores for the interviewee responses, a confidence score for the assessment. The machine-learning model can generate the report including one or more of the confidence scores for the interviewee responses, the confidence scores for the assessment inputs, and the confidence score for the assessment.

The machine-learning model can generate, based on the interview transcript and/or the confidence scores for the interviewee responses, and/or raw sensor data such as biometric data, an overall veracity score (e.g., veracity confidence score) for the interviewee representing a confidence that the interviewee was truthful during the assessment interview.

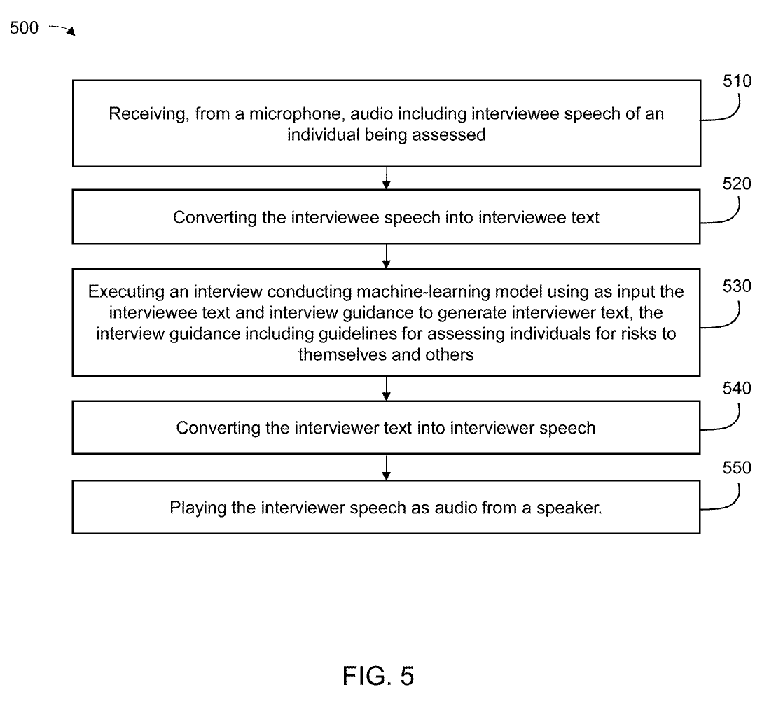

FIG. 5 is a flow chart illustrating operations of an example method 500 for automatically conducting assessment interviews. The method 500 can include more, fewer, or different operations than shown. One or more operations can be performed in the order shown, in a different order, or concurrently. The method 500 can be performed by one or more components of the system 200 of FIG. 2 or the system 300 of FIG. 3.

At operation 510, audio including interviewee speech of an individual being assessed is received from a microphone. The audio may be captured in real-time during an assessment interview session where the individual provides verbal responses to interview questions. In some implementations, the audio is received continuously throughout the interview process to capture all spoken interactions between the interviewer and interviewee. The received audio may include background noise, ambient sounds, and other acoustic information in addition to the primary speech content. In one example, the microphone captures audio of an individual responding to questions about their employment history and substance use patterns during a pre-release assessment interview. In another example, the audio includes an individual's verbal responses regarding their family relationships and support systems as part of a comprehensive risk evaluation process. In some implementations, the interviewer is a human interviewer. In some implementations, the interviewer is an artificial, computer-executed interviewer, such as an interview conducting machine-learning model.

At operation 520, the interviewee speech is converted into interviewee text. Speech-to-text conversion may be performed using machine-learning models trained to recognize and transcribe human speech patterns. The conversion process may account for variations in speech clarity, accent, speaking pace, and pronunciation to generate accurate text representations. In some cases, the conversion includes identification and correction of speech recognition errors through contextual analysis and language modeling techniques. Natural language processing algorithms may be applied to structure the converted text and identify sentence boundaries, punctuation, and grammatical elements. In one example, an individual's spoken response about their criminal history is converted into structured text that captures specific details about dates, locations, and circumstances of past offenses. In another example, verbal descriptions of mental health symptoms and treatment history are transcribed into text format that preserves medical terminology and temporal relationships between events.

At operation 530, an interview conducting machine-learning model is executed using as input the interviewee text and interview guidance to generate interviewer text. The interview guidance includes guidelines for assessing individuals for risks to themselves and others. The machine-learning model may analyze the interviewee text to identify key themes, concerns, and areas requiring further exploration based on the assessment framework. Interview guidance may provide structured prompts and question templates that direct the model toward collecting information relevant to risk prediction and intervention planning. The generated interviewer text may include follow-up questions, clarifying inquiries, and empathetic responses designed to encourage continued disclosure from the interviewee. In one example, after receiving text indicating an individual has experienced recent job loss, the model generates interviewer text asking about financial stress, coping mechanisms, and available support resources. In another example, when interviewee text reveals a history of substance abuse, the model produces interviewer text exploring current usage patterns, treatment experiences, and relapse triggers.

At operation 540, the interviewer text is converted into interviewer speech. Text-to-speech synthesis may be performed using machine-learning models that generate natural-sounding audio from written text input. The conversion process may incorporate prosodic features such as intonation, stress patterns, and speaking rhythm to create speech that sounds conversational and engaging. Voice characteristics may be selected to match appropriate professional tones and speaking styles suitable for assessment interviews. The generated speech may be optimized for clarity and comprehensibility to ensure effective communication with individuals from diverse backgrounds and education levels. In one example, interviewer text asking about family support is converted into speech with a warm, encouraging tone that promotes openness and trust during the interview process. In another example, questions about sensitive topics such as mental health history are converted into speech with appropriate pacing and empathetic inflection to create a supportive interview environment.

At operation 550, the interviewer speech is played as audio from a speaker. The audio playback may be synchronized with the interview flow to maintain natural conversational timing and pacing. The playback process may include pauses and timing adjustments to allow for interviewee processing time and response formulation. Audio delivery may be coordinated with visual displays or other interface elements to create a comprehensive interview experience. In one example, questions about employment goals are played through speakers positioned to create an intimate, one-on-one conversation atmosphere in an interview room. In another example, follow-up questions about treatment compliance are delivered through high-quality speakers that ensure clear communication even when background noise is present in the interview environment.

In some implementations, sensor data is received from a plurality of sensors including the microphone, and the interview conducting machine-learning model is executed using the sensor data as input. The sensor data may provide additional context and behavioral indicators that inform the interview process and question generation. Multiple sensors may operate simultaneously to capture comprehensive information about the interviewee's state and responses during the assessment. Sensor integration may enable real-time adaptation of interview strategies based on physiological and behavioral feedback. The machine-learning model may analyze sensor patterns to identify optimal timing for sensitive questions or to detect when additional support or clarification may be needed. In one example, heart rate data from biometric sensors indicates elevated stress when discussing family relationships, prompting the model to generate more supportive and gradual questioning approaches. In another example, video analysis of facial expressions and body language provides input that helps the model determine when an interviewee may be experiencing confusion or discomfort with particular topics.

The sensor data may include at least one of audio of the individual, video of the individual, heart rate of the individual, eye movement of the individual, temperature of the individual, ambient temperature, and humidity. Audio sensors may capture not only speech content but also vocal stress indicators, speaking patterns, and emotional tone variations. Video sensors may record facial expressions, body posture, hand movements, and other visual cues that provide insight into the interviewee's emotional state and engagement level. Biometric sensors may monitor physiological responses such as heart rate variability, skin conductance, and breathing patterns that can indicate stress, deception, or other relevant psychological states. Environmental sensors may track ambient conditions that could affect interview quality or interviewee comfort. In one example, eye tracking sensors detect patterns of gaze avoidance when discussing substance abuse history, providing input for generating more indirect or supportive questioning approaches. In another example, temperature and humidity sensors identify environmental conditions that may be causing discomfort, prompting adjustments to interview pacing or breaks in the assessment process.

A transcript of the assessment interview may be generated based on the interviewee text and the interviewer text. The transcript may provide a comprehensive record of all verbal exchanges during the interview process, including both questions and responses. Transcript generation may include timestamps, speaker identification, and formatting that facilitates subsequent analysis and review. The transcript may serve as a permanent record for quality assurance, legal compliance, and ongoing case management purposes. Automated transcript generation may reduce administrative burden while ensuring accurate documentation of assessment interviews. In one example, a transcript captures the complete conversation flow during a pre-trial risk assessment, including all questions about criminal history, substance use, and community ties. In another example, the transcript documents a parole evaluation interview, preserving detailed discussions about rehabilitation progress, employment plans, and family support systems.

The transcript may include questions asked of the interviewee, analysis used to generate the questions, and responses from the interviewee. Question analysis may provide insight into the reasoning and decision-making processes of the interview conducting machine-learning model. The inclusion of analytical reasoning may enhance transparency and explainability of the automated interview process. Response documentation may capture not only the content of interviewee answers but also relevant contextual information and behavioral observations. Comprehensive transcript content may support quality control processes and enable continuous improvement of interview techniques. In one example, the transcript shows that questions about employment history were generated based on analysis indicating high correlation between job stability and recidivism risk, along with the interviewee's detailed responses about work experience and career goals. In another example, the transcript documents how questions about mental health treatment were formulated based on analysis of previous responses indicating potential depression symptoms, followed by the interviewee's explanations of their therapeutic experiences and medication compliance.

A mapping of the questions to the responses may be generated based on the interview transcript, confidence scores for the responses may be generated, and assessment inputs may be generated based on the responses, the corresponding confidence scores, and the mapping. The mapping process may establish clear relationships between specific interview questions and corresponding interviewee responses to facilitate accurate data extraction. Confidence scoring may evaluate the reliability and completeness of responses based on various factors including consistency, detail level, and corroborating information. Assessment input generation may transform conversational interview content into structured data suitable for risk prediction models and decision-making algorithms. The integration of mapping, confidence scoring, and input generation may ensure that assessment results are based on high-quality, well-documented interview data. In one example, questions about substance abuse history are mapped to specific responses about drug types and usage patterns, assigned confidence scores based on response detail and consistency, and converted into assessment inputs for addiction risk evaluation models. In another example, employment-related questions are mapped to responses about job skills and work history, scored for completeness and verifiability, and transformed into inputs for economic stability and recidivism risk assessments.

An evaluation of interviewer questions may be generated based on the interview transcript. The evaluation process may assess the effectiveness of questions in eliciting relevant information for risk assessment purposes. Question evaluation may consider factors such as clarity, appropriateness, and alignment with assessment objectives. The evaluation may identify areas for improvement in interview techniques and question formulation strategies. Systematic evaluation of interviewer performance may support continuous refinement of automated interview processes and enhance overall assessment quality. In one example, evaluation analysis determines that questions about family relationships successfully elicited detailed information about support systems but failed to adequately explore potential sources of conflict or stress. In another example, the evaluation identifies that employment-related questions effectively gathered information about work history but did not sufficiently address barriers to future employment or vocational training needs.

The evaluation of interviewer questions may be generated by executing an evaluation machine-learning model using as input the interview transcript and the confidence scores for the responses. The evaluation model may analyze patterns in question effectiveness and response quality to provide systematic feedback on interview performance. Machine-learning approaches to evaluation may identify relationships between question characteristics and response reliability that might not be apparent through manual review. The evaluation model may be trained on large datasets of successful interviews to recognize optimal questioning strategies and techniques. Automated evaluation processes may provide consistent, objective assessments of interview quality across different interviewers and assessment contexts. In one example, the evaluation model analyzes transcripts from hundreds of interviews to determine that open-ended questions about coping strategies generate higher confidence scores and more detailed responses than closed-ended alternatives. In another example, the model identifies that questions incorporating empathetic language and acknowledgment of previous responses result in improved interviewee engagement and more complete information disclosure.

The generation of confidence scores for the responses may be based on sensor data collected during the interview. Sensor data may provide objective indicators of response reliability, emotional state, and potential deception that complement verbal content analysis. Physiological measurements may reveal stress patterns, cognitive load, and other factors that influence response accuracy and completeness. Integration of sensor data with response analysis may enhance the precision and reliability of confidence scoring algorithms. Multi-modal confidence assessment may provide more robust evaluation of interview quality than approaches based solely on verbal content. In one example, elevated heart rate and skin conductance during questions about criminal history result in lower confidence scores for related responses, indicating potential stress or deception. In another example, consistent physiological baselines and stable vocal patterns during employment discussions support higher confidence scores for responses about work experience and career goals.

An overall veracity score for the individual may be generated based on the confidence scores for the responses. The veracity score may provide a comprehensive assessment of truthfulness and reliability across the entire interview process. Overall scoring may weight different response areas based on their importance to risk assessment and decision-making outcomes. The veracity score may serve as a quality indicator for the assessment results and inform decisions about the need for additional verification or follow-up interviews. Systematic veracity assessment may enhance the reliability and defensibility of automated assessment processes in legal and administrative contexts. In one example, an individual receives a high overall veracity score based on consistent, detailed responses across multiple topic areas, supporting confidence in the resulting risk assessment and intervention recommendations. In another example, a lower veracity score based on inconsistent responses and physiological stress indicators prompts additional verification through external records and follow-up interviews before finalizing assessment results.

In a specific implementation example, a correctional facility deploys an automated assessment interview system to evaluate inmates prior to parole hearings. The system includes a dedicated interview room equipped with multiple sensors: a high-fidelity microphone array, a 4K video camera with facial recognition capabilities, biometric sensors embedded in the chair armrests for heart rate and skin conductance monitoring, eye-tracking cameras, and environmental sensors measuring temperature and humidity.

When an inmate enters the interview room, the system initiates the assessment process by activating all sensors simultaneously. The microphone array captures the inmate's speech with noise cancellation technology, while the video camera records facial expressions and body language at 60 frames per second. The biometric sensors establish baseline physiological measurements during an initial calibration period where the system asks neutral questions about the inmate's name and identification number.

The interview conducting machine-learning model, implemented as a large language model trained specifically on correctional assessment protocols, begins the formal interview by generating questions about the inmate's criminal history. When the inmate responds about their conviction for armed robbery, the speech-to-text model converts their verbal response into structured text, capturing not only the words but also speech patterns, hesitation markers, and vocal stress indicators. Simultaneously, the biometric sensors detect a 15% increase in heart rate and elevated skin conductance, while the eye-tracking system records increased saccadic movements and reduced direct eye contact with the camera.

The machine-learning model processes this multi-modal input and generates a follow-up question designed to explore the inmate's understanding of the impact of their crime on victims. The text-to-speech system converts this question into natural-sounding audio with appropriate pacing and empathetic tone, which plays through high-quality speakers positioned to create an intimate conversational environment. The system continues this process for 45 minutes, covering topics including substance abuse history, family relationships, employment prospects, and rehabilitation participation.

Throughout the interview, the interpretation engine continuously analyzes the growing transcript in real-time. When the inmate discusses their participation in a drug treatment program, the system cross-references their statements with external databases containing program completion records. The interpretation engine identifies a discrepancy between the inmate's claim of completing the program and official records showing early termination, automatically flagging this inconsistency for further exploration.

The quality control engine processes the complete sensor data stream alongside the final transcript. The system's veracity detection algorithms analyze vocal stress patterns, identifying specific moments where the inmate's speech exhibited characteristics associated with deception, particularly when discussing future employment plans. The eye-tracking data reveals patterns of gaze aversion during questions about substance use, while physiological monitoring shows stress responses that correlate with discussions of family relationships.

The system generates a comprehensive assessment input dataset, mapping each interview response to specific assessment criteria required for parole evaluation. For substance abuse risk, the system extracts detailed information about drug types, usage patterns, and treatment history, assigning confidence scores based on response consistency and physiological indicators. Employment stability assessments incorporate the inmate's work history, vocational training completion, and concrete job prospects, with confidence scores reflecting the verifiability of their claims through external employment databases.

The analysis engine processes these structured inputs through validated risk prediction models, generating specific risk scores for recidivism, substance abuse relapse, and employment stability. The system produces a detailed report indicating a 73% likelihood of successful reintegration based on the inmate's responses, but flags concerns about truthfulness regarding substance use history due to physiological stress indicators and inconsistent statements.

The technical advantages of this implementation include elimination of interviewer bias through standardized questioning protocols, reduction of assessment time from 3 hours to 45 minutes while maintaining comprehensive coverage, and generation of objective veracity scores that supplement subjective human judgment. The system's ability to process multiple data streams simultaneously provides insights unavailable to human interviewers, such as correlating physiological responses with specific topics to identify areas requiring additional investigation. The automated transcript generation with embedded reasoning creates an auditable trail of decision-making processes, supporting requirements for transparent and defensible assessment procedures.

The quality control engine's real-time feedback capabilities enable immediate identification of incomplete or unreliable responses, allowing the interview to adapt dynamically rather than requiring follow-up sessions. The system's integration with external databases provides immediate verification of factual claims, reducing the administrative burden of manual record checking while improving assessment accuracy. This comprehensive approach results in more consistent, objective, and thorough evaluations that support evidence-based decision-making in parole proceedings while maintaining detailed documentation for legal and administrative review.

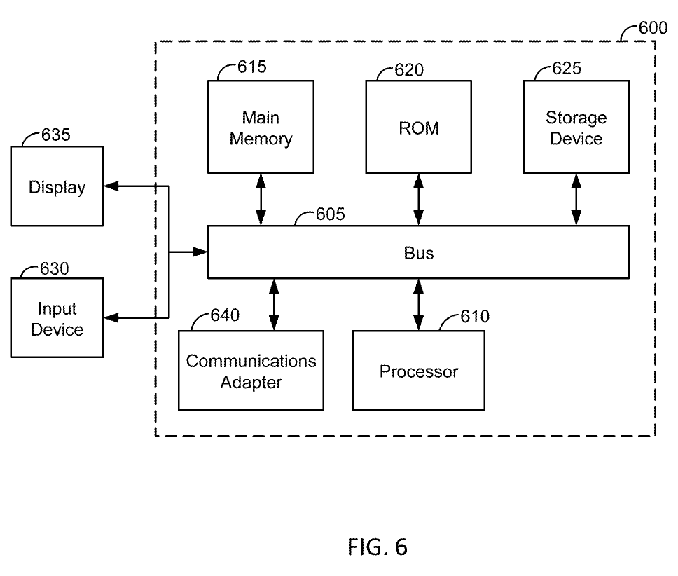

FIG. 6 is an illustration of an example computer system 600. The computer system 600 may be used, for example, to implement the system 100 of FIG. 1, the system 200 of FIG. 2, the system 300 of FIG. 3 and/or various components of the system 100 of FIG. 1, the system 200 of FIG. 2, the system 300 of FIG. 3. The computing system 600 may be used, for example, the perform the method 400 of FIG. 4 and the method 500 of FIG. 5, and/or various operations of the method 400 of FIG. 4 and the method 500 of FIG. 5. The computing system 600 includes a bus 605 or other communication component for communicating information and a processor 610 coupled to the bus 605 for processing information. The computing system 600 also includes main memory 615, such as a random-access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 620 or other static storage device coupled to the bus 605 for storing static information and instructions for the processor 610. A storage device 625, such as a solid-state device, magnetic disk, or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information, and command selections to the processor 610. In another implementation, the input device 630 has a touch screen display 635. The input device 630 can include any type of biometric sensor, a cursor control, such as a mouse, a trackball, or cursor direction keys, for communicating direction information and command selections to the processor 610 and for controlling cursor movement on the display 635.

In some implementations, the computing system 600 may include a communications adapter 640, such as a networking adapter. In various illustrative implementations, any type of networking configuration may be achieved using communications adapter 640, such as wired (e.g., via Ethernet), wireless (e.g., via Wi-Fi, Bluetooth), satellite (e.g., via GPS) pre-configured, ad-hoc, LAN, WAN.

According to various implementations, the processes that effectuate illustrative implementations that are described herein may be achieved by the computing system 600 in response to the processor 610 executing an implementation of instructions contained in main memory 615. Such instructions may be read into main memory 615 from another computer-readable medium, such as the storage device 625. Execution of the implementation of instructions contained in main memory 615 causes the computing system 600 to perform the illustrative processes described herein. One or more processors in a multi-processing implementation may also be operated to execute the instructions contained in main memory 615. In alternative implementations, hard-wired circuitry may be used in place of or in combination with software instructions to implement illustrative implementations. Thus, implementations are not limited to any specific combination of hardware circuitry and software.

That is, although an example processing system has been described in FIG. 6, implementations of the subject matter and the functional operations described in this specification may be carried out using other types of digital electronic circuitry, or in computer software embodied on a tangible medium, firmware, or hardware, including the structures disclosed in this specification and their structural equivalents, or in combinations of one or more of them. Implementations of the subject matter described in this specification may be implemented as one or more computer programs, e.g., one or more subsystems of computer program instructions, encoded on one or more computer storage medium for execution by, or to control the operation of, data processing apparatus. Alternatively, or in addition, the program instructions may be encoded on an artificially generated propagated signal, e.g., a machine generated electrical, optical, or electromagnetic signal, that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the implementations of FIG. 6 as singular, stand-alone devices, one of ordinary skill in the art will appreciate that, in some implementations, the computing system 600 may include virtualized systems and/or system resources. For example, in some implementations, the computing system 600 may be a virtual switch, virtual router, virtual host, or virtual server. In various implementations, computing system 600 may share physical storage, hardware, and other resources with other virtual machines. In some implementations, virtual resources of the network may include cloud computing resources such that a virtual resource may rely on distributed processing across more than one physical processor, distributed memory, etc.

### EXAMPLES

Example 1: A computer-implemented method for automatically conducting assessment interviews, the method comprising receiving, from a microphone, audio including interviewee speech of an individual being assessed, converting the interviewee speech into interviewee text, executing an interview conducting machine-learning model using as input the interviewee text and interview guidance to generate interviewer text, the interview guidance including guidelines for assessing individuals for risks to themselves and others, converting the interviewer text into interviewer speech, and playing the interviewer speech as audio from a speaker.

Example 2: A computer-readable medium storing instructions which, when executed by one or more processors, cause the one or more processors to receive, from a microphone, audio including interviewee speech of an individual being assessed, convert the interviewee speech into interviewee text, execute an interview conducting machine-learning model using as input the interviewee text and interview guidance to generate interviewer text, the interview guidance including guidelines for assessing individuals for risks to themselves and others, convert the interviewer text into interviewer speech, and play the interviewer speech as audio from a speaker.

Example 3: A system to automatically conducting assessment interviews, comprising: a microphone to receive audio including interviewee speech of an individual being assessed, one or more processors to convert the interviewee speech into interviewee text, execute an interview conducting machine-learning model using as input the interviewee text and interview guidance to generate interviewer text, the interview guidance including guidelines for assessing individuals for risks to themselves and others, and convert the interviewer text into interviewer speech, and a speaker to play the interviewer speech as audio.

Example 4: A computer-implemented method for generating assessments of individuals based on interview transcripts, the method comprising receiving, from a database, an interview transcript of an interview to assess an individual for risks to self and others, generating a mapping of assessment questions to responses derived from the interview transcript, generating confidence scores for the responses, based on the responses, the corresponding confidence scores, and the mapping, generating assessment inputs, and providing the assessment inputs as input to an analysis engine to generate an assessment of the individual, the assessment reflecting a prediction of risks the individual poses to self and others.

Example 5: A computer-implemented method for evaluating a machine-learning architecture configured to automatically generate assessments of individuals based on interview transcripts, the method comprising receiving an assessment of an individual including a prediction of risks the individual poses to self and others, the assessment generated by an analysis engine based on assessment inputs provided by an interpretation engine executed using as input an interview transcript of an interview to assess the individual, receiving sensor data collected during the interview to assess the individual, based on the interview transcript and the sensor data, generating confidence scores for interviewee responses in the interview transcript, based on the interview transcript, the confidence scores for the interviewee responses, and the assessment inputs, generating confidence scores for the assessment inputs, based on the confidence scores for the assessment inputs, generating a confidence score for the assessment, and generating a report including one or more of the confidence scores for the interviewee responses, the confidence scores for the assessment inputs, and the confidence score for the assessment.

Example 6: A computer-implemented method comprising automatically conducting an assessment interview to predict risks an individual poses to self an others by executing an interview conducting machine-learning model using as input interviewee responses and interview guidance to generate interviewer questions and responses, the interview guidance including guidelines for assessing individuals for risks to themselves and others, and generating an interview transcript including the interviewer questions, the interviewee responses, and the interviewer responses, automatically generating assessment inputs based on the assessment interview by generating, based on the interviewee responses, assessment inputs, and providing the assessment inputs as input to an analysis engine to generate an assessment of the individual, the assessment reflecting a prediction of risks the individual poses to self and others, automatically generating a report on the assessment by generating, based on the interview transcript and sensor data collected during the assessment interview, a confidence score for the assessment.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the monitoring device 102) to perform actions by operating on input data and generating an output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer-implemented method for automatically conducting assessment interviews, the method comprising:
receiving, from a microphone, audio including interviewee speech of an individual being assessed;
converting the interviewee speech into interviewee text;
executing an interview conducting machine-learning model using as input the interviewee text and interview guidance to generate interviewer text, the interview guidance including guidelines for assessing individuals for risks to themselves and others;
converting the interviewer text into interviewer speech; and
playing the interviewer speech as audio from a speaker.

2. The method of claim 1, further comprising receiving, from a plurality of sensors including the microphone, sensor data, wherein executing the interview conducting machine-learning model comprises executing the interview conducting machine-learning model using as input the sensor data.

3. The method of claim 2, wherein the sensor data includes at least one of audio of the individual, video of the individual, heart rate of the individual, eye movement of the individual, temperature of the individual, ambient temperature, and humidity.

4. The method of claim 1, further comprising generating, based on the interviewee text and the interviewer text, a transcript of the assessment interview.

5. The method of claim 4, wherein the transcript includes questions asked of the individual, analysis used to generate the questions, and responses from the individual.

6. The method of claim 5, further comprising:
generating a mapping of the questions to the responses based on the interview transcript;
generating confidence scores for the responses;
based on the responses, the corresponding confidence scores, and the mapping, generating assessment inputs; and
providing the assessment inputs as input to an analysis engine to generate an assessment of the individual, the assessment reflecting a prediction of risks the individual poses to self and others.

7. The method of claim 6, further comprising generating, based on the interview transcript, an evaluation of interviewer questions.

8. The method of claim 7, wherein generating the evaluation of the interviewer questions includes executing an evaluation machine-learning model using as input the interview transcript and the confidence scores for the responses.

9. The method of claim 6, wherein generating the confidence scores for the responses is based on sensor data collected during the interview.

10. The method of claim 6, further comprising generating an overall veracity score for the individual based on the confidence scores for the responses.

11. A computer-readable medium storing instructions which, when executed by one or more processors, cause the one or more processors to:
receive, from a microphone, audio including interviewee speech of an individual being assessed;
convert the interviewee speech into interviewee text;
execute an interview conducting machine-learning model using as input the interviewee text and interview guidance to generate interviewer text, the interview guidance including guidelines for assessing individuals for risks to themselves and others;
convert the interviewer text into interviewer speech; and
play the interviewer speech as audio from a speaker.

12. The computer-readable medium of claim 11, wherein the instructions further cause the one or more processors to receive, from a plurality of sensors including the microphone, sensor data, wherein executing the interview conducting machine-learning model comprises executing the interview conducting machine-learning model using as input the sensor data.

13. The computer-readable medium of claim 12, wherein the sensor data includes at least one of audio of the individual, video of the individual, heart rate of the individual, eye movement of the individual, temperature of the individual, ambient temperature, and humidity.

14. The computer-readable medium of claim 11, wherein the instructions further cause the one or more processors to generate, based on the interviewee text and the interviewer text, a transcript of the assessment interview.

15. The computer-readable medium of claim 14, wherein the transcript includes questions asked of the interviewee, analysis used to generate the questions, and responses from the interviewee.

16. The computer-readable medium of claim 15, wherein the instructions further cause the one or more processors to:
generate a mapping of the questions to the responses based on the interview transcript;
generate confidence scores for the responses;
based on the responses, the corresponding confidence scores, and the mapping, generate assessment inputs; and
provide the assessment inputs as input to an analysis engine to generate an assessment of the individual, the assessment reflecting a prediction of risks the individual poses to self and others.

17. The computer-readable medium of claim 16, wherein the instructions further cause the one or more processors to generate, based on the interview transcript, an evaluation of interviewer questions.

18. The computer-readable medium of claim 17, wherein generating the evaluation of the interviewer questions includes executing an evaluation machine-learning model using as input the interview transcript and the confidence scores for the responses.

19. The computer-readable medium of claim 16, wherein generating the confidence scores for the responses is based on sensor data collected during the interview.

20. The computer-readable medium of claim 16, wherein the instructions further cause the one or more processors to generate an overall veracity score for the individual based on the confidence scores for the responses.

21. A system to automatically conducting assessment interviews, comprising:
a microphone to receive audio including interviewee speech of an individual being assessed;
one or more processors to:
convert the interviewee speech into interviewee text;
execute an interview conducting machine-learning model using as input the interviewee text and interview guidance to generate interviewer text, the interview guidance including guidelines for assessing individuals for risks to themselves and others; and
convert the interviewer text into interviewer speech; and
a speaker to play the interviewer speech as audio.

22. The system of claim 21, further comprising:
a plurality of sensors including the microphone, to collect sensor data,
wherein the one or more processors are further to receive the sensor data and to execute the interview conducting machine-learning model using as input the sensor data.

23. The system of claim 21, the one or more processors further to:
generate, based on the interviewee text and the interviewer text, a transcript of the assessment interview, wherein the transcript includes questions asked of the individual, analysis used to generate the questions, and responses from the individual;
generate a mapping of the questions to the responses based on the interview transcript;
generate confidence scores for the responses;
generate assessment inputs according to the responses, the corresponding confidence scores, and the mapping; and
provide the assessment inputs for input to an analysis engine to generate an assessment of the individual, the assessment reflecting a prediction of risks the individual poses to self and others.

24. The system of claim 23, the one or more processors further to:
generate, based on the interview transcript, an evaluation of interviewer question,
wherein generating the evaluation of the interviewer questions includes executing an evaluation machine-learning model using as input the interview transcript and the confidence scores for the responses.

25. The system of claim 23, the one or more processors further to:
generate an overall veracity score for the individual based on the confidence scores for the responses.
